(19) United States
(12) Patent Application Publication
(10) Pub. No.: US 2009/0108167 A1
(43) Pub. Date: Apr. 30, 2009

(54) Cane/Umbrella Stand or Holder

(76) Inventor: Katherine S. White, North Grafton, MA (US)

Correspondence Address: Katherine S. White, 60 Edward Dr., North Grafton, MA, 01536, US

(21) Appl. No.: 12/048,153

(22) Filed: Mar. 13, 2008

Related U.S. Application Data
(60) Provisional application No. 60/895,417, filed on Mar. 16, 2007.

(51) Int. Cl. F16M 13/00

(52) U.S. Cl. 248/519

(57) ABSTRACT

A cane and umbrella stand for storing walking canes and umbrellas. The cane stand is made up of a base attached to a shaft at one end with a bell shaped cylindrical shaft at its lowest point. A circular base is fixedly attached to the end of the shaft that is perpendicular to the base. When the cane is stored in a vertical position, the cane fits into the base via a vertical shaft.

This application emanates from a previously filed provisional application; 60/895,417 filed on Mar. 16, 2007

### FIELD OF THE INVENTION

The invention pertains to the field of portable holders for umbrellas and canes. More particularly, the invention pertains to a holder that temporarily and vertically holds the shaft of a cane to store the cane in an upright position.

### BACKGROUND OF THE INVENTION

The invention has a single cylinder that is sturdy and easy to insert a walking cane or umbrella into the top. It improves the ability to hold your cane or umbrella upright and in sight.

Canes are used by a large percentage of the population. One of the problems associated with canes is storage. Often times, the cane has to be hung off of a table where any activity around the cane can cause it to fall or be put far out of reach, making the cane inaccessible when the person first gets up. Furthermore, it is very difficult to compactly store a cane in an upright is very difficult to compactly store a cane in an upright position. For example, when a person is out in public, for example in a restaurant a person usually has to store their cane either under their chair, on another chair not being used, against a wall, far out of reach, or hung off the table, so as not to block a path for the other patrons of the restaurant or the wait staff.

Various solutions have been proposed for storing a cane in an upright, vertical position. For example, U.S. Pat. No. 3,392,946 (Stromberg) discloses a self standing device comprising a housing with a plurality of movable legs, and an extending/retracting means adapted to readily secure to the lower end of a cane, crutch, or the like. Another example is U.S. Pat. No. 5,456,437 (Chander et. al.), which discloses a clamp forming part of a vertical member that is pivotally attached to a flat plane, where the clamping portion holds the shaft of a cane, crutch or the like, in a temporary fixed position, with the cane, crutch, or the like resting on the floor. The invention also includes a plate with a non-skid surface, which pivots so that it can be placed on a horizontal surface such as a tabletop or bench and the back of the vertical member can still holds the cane, crutch, or the like in a vertical position.

### SUMMARY OF THE INVENTION

A portable cane and umbrella stand for vertically storing a cane and umbrella. The cane stand comprises a base; a shaft vertically mounted to the base at the top most ends so that the shaft can be placed relative to the base, and an oversized entry point opposite the base.

When the cane is being stored in a vertical position, the cane is received by the device from a vertical position and held in the vertical position.

### BRIEF DESCRIPTION OF THE DRAWING

FIG. 1 shows a side view of the present invention.

FIG. 2 shows a top down view of the present invention.

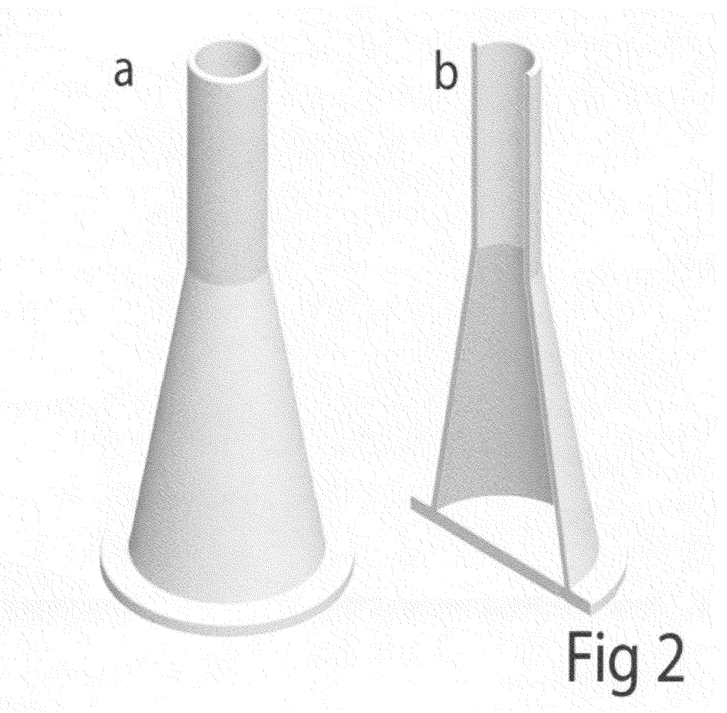

FIG. 3 shows the present invention storing a cane.

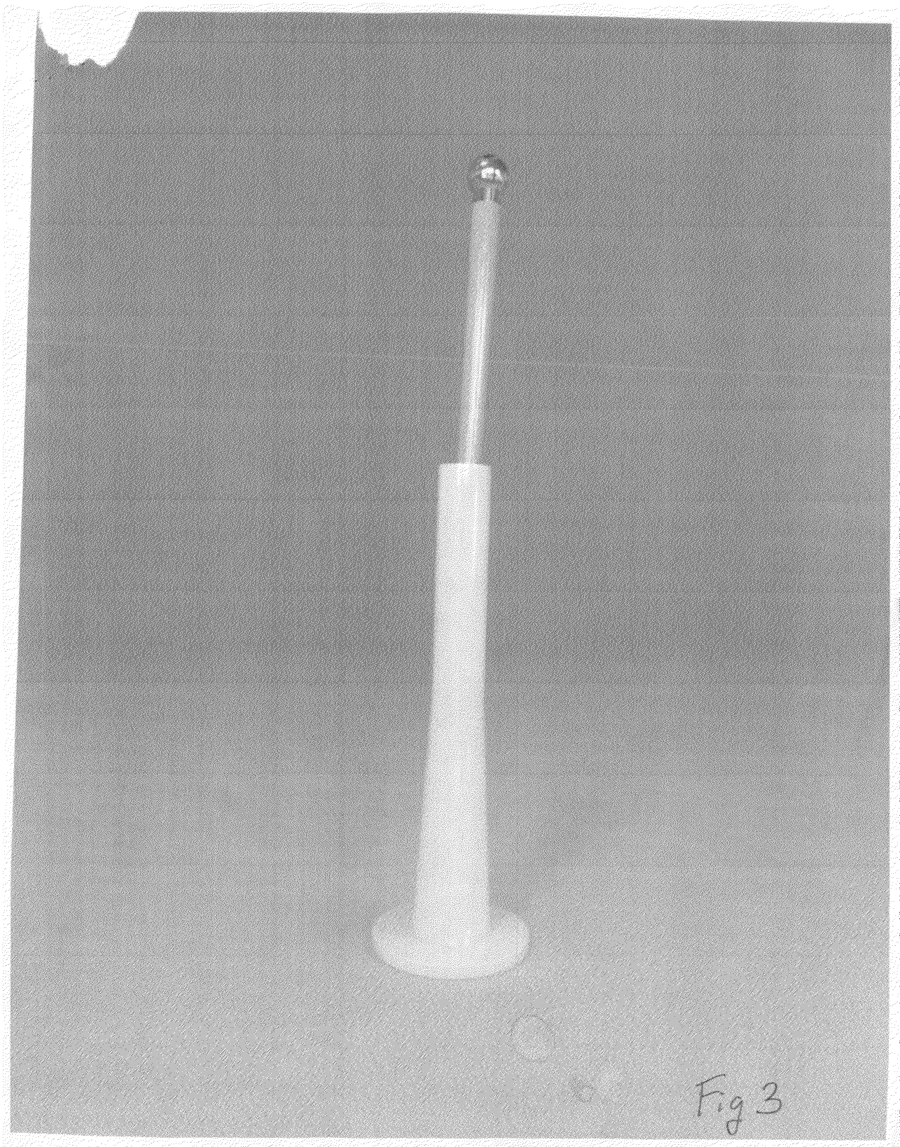

### DETAILED DESCRIPTION OF THE INVENTION

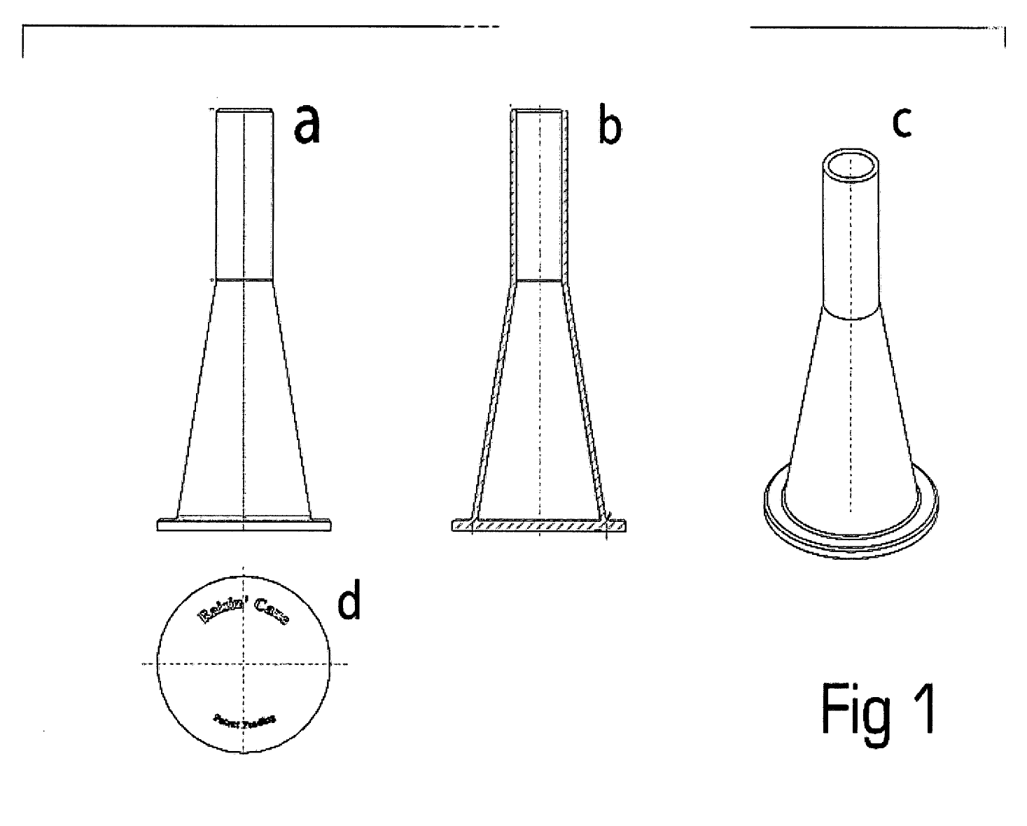

FIG. 1 a. Round base that has a diameter of 6 inches and is one inch thick. In the center of the base is a hole with a diameter of 2.01 inches and is ½ inches deep. The cylinder is hollow and measures 10-12 inches in length, with a top O.D. of 1¾ inches and a bottom O.D. of two inches.

The cylinder and base are made of acrylic or PVC. The cylinder is attached to the base using a glue and placing it in the hole in the base.

FIG. 1 d. Is the bottom of the base.

All over figures are just showing the invention cut in half and viewed from the top.

The storage of canes is a problem in that the storage is often not present where the person is sitting and it is not compact. The present invention is a lightweight, portable, and compact, cane holder.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A freestanding cane and umbrella holder comprising:
a) a base plate having a cutout for receiving an end of a cane;
b) a shaft having a first end and a second end, the shaft being mounted to a middle portion of the base at the first end;
c) a shaft having a wider opening at the receiving or top most end.

2. The cane stand of claim 1, wherein the base is circular in shape.

3. The cane stand of claim 1, wherein the shaft is mounted vertically from the base.

4. The cane stand of claim 1, in which the shaft is bell shaped with the larger diameter located at the base.

5. The cane stand of claim 1, wherein the stand base has a diameter of six inches and is one inch thick.

6. The cane stand of claim 1, wherein the cylinder is hollow and measures ten to twelve inches in length, with a top O.D. of one and three quarter inches and a bottom O.D. of two inches.

7. The cane stand of claim 1, wherein the cylinder and base are made of acrylic or PVC.
